(19) United States
(12) Patent Application Publication
(10) Pub. No.: US 2023/0040564 A1
(43) Pub. Date: Feb. 9, 2023

(54) Learning Causal Relationships

(71) Applicant: International Business Machines Corporation, Armonk, NY (US)

(72) Inventors: Qing Wang, Chappaqua, NY (US); Karthikeyan Shanmugam, Elmsford, NY (US); Jesus Maria Rios Aliaga, Philadelphia, PA (US); Larisa Shwartz, Greenwich, CT (US); Naoki Abe, Rye, NY (US); Frank Bagehorn, Dottikon (CH); Daniel Firebanks-Quevedo, New York, NY (US)

(73) Assignee: International Business Machines Corporation, Armonk, NY (US)

(21) Appl. No.: 17/393,130

(22) Filed: Aug. 3, 2021

(51) Int. Cl. G06N 7/00; G06N 5/04; G06K 9/62; G06F 11/07

(52) U.S. Cl. CPC G06N 7/005; G06N 5/04; G06K 9/6276; G06K 9/6215; G06F 11/0781; G06F 11/0775; G06F 2201/86

(57) ABSTRACT

A computer-implemented method is provided that includes learning causal relationships between two or more application micro-services, and applying the learned causal relationships to dynamically localize an application fault. First micro-service error log data corresponding to selectively injected errors is collected. A learned causal graph is generated based on the collected first micro-service error log data. Second micro-service error log data corresponding to a detected application and an ancestral matrix is built using the learned causal graph and the second micro-service error log data. The ancestral matrix is leveraged to identify the source of the error, and the micro-service associated with the identified error source is also subject to identification. A computer system and a computer program product are also provided.

### BACKGROUND

The present embodiments relate to a system, a computer program product, and a computer-implemented method for leveraging causal intervention to infer a causal graph among application micro-services via active causal learning, and to leverage the learned causal graph to perform fault localization.

It is understood in the art that a monolithic application is a self-contained application independent from other applications. Micro-services or a micro-service architecture typically refer to a computer environment in which an application is built as a suite of modular components or services based on function definitions, and each running its own process and communicating by way of lightweight mechanisms. In certain micro-service architecture, data is stored outside of the service, and as such the service is stateless, and these services or components are commonly referred to as “atomic services”. Each atomic service is a lightweight component for independently performing a modular service; each atomic service supports a specific task and uses a defined interface, such as an application programming interface (API) to communicate with other services. The micro-service architecture supports and enables scalability in a hybrid network.

Generally, micro-services are an architectural approach, often cloud native, in which a single application is composed of multiple loosely coupled and independently deployable smaller components or services, referred to as micro-services. The micro-services typically (but not necessarily) have their own stack, inclusive of a database and data model, communicate with one another over a combination of representational state transfer (REST) application program interfaces (APIs), and are organized by business entity. Industrial micro-service applications have hundreds or more micro-services, some of which have dependent relationships. As the quantity of application micro-services expands, the dependency relationships among the micro-services grow in complexity. The topology of the application's micro-services may be fixed, but is often unknown.

The complexity of the micro-service dependent relationships together with the often unknown micro-service topology leads to complexity and inefficiency of fault localization. It would be a significant advancement to develop a system, a computer program product, and a computer-implemented method that can perform fault localization of application micro-services. In particular exemplary embodiments, the system, computer program product, and computer-implemented method are operable with minimal observational data in a production environment.

### SUMMARY

The embodiments include a system, a computer program product, and a method for learning causal relationships between application micro-services, and dynamically leveraging the learned causal relationships for fault localization. This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

In an aspect, a computer system is provided with a processor operatively coupled to memory, and an artificial intelligence (AI) platform in communication with the processor and the memory. The AI platform includes a staging manager, and a production manager and a director are operatively coupled to the AI platform. The staging manager is configured to learn causal relationships between two or more application micro-services. First micro-service error log data corresponding to one or more selectively injected errors is collected and a learned causal graph is generated based on the collected first micro-service error log data. The learned causal graph represents dependency of application micro-services effected by the selective error injunction. The production manager, operatively coupled to the staging manager, is configured to dynamically localize a source of an application error. Second micro-service error log data corresponding to the application error is collected and an ancestral matrix is built based on the learned causal graph and the collected second micro-service error log data. The ancestral matrix is leveraged to identify the source of the error. The director, operatively coupled to the production manager, is configured to identify the micro-service associated with the identified error source.

In another aspect, a computer-implemented method is provided for learning causal relationships between two or more application micro-services. First micro-service error log data corresponding to one or more selectively injected errors is collected and a learned causal graph is generated based on the collected first micro-service error log data. The learned causal graph represents dependency of application micro-services effected by the selective error injunction. A source of an application error is dynamically localized, which is manifested in the collection of second micro-service error log data corresponding to the application error and building an ancestral matrix based on the learned causal graph and the collected second micro-service error log data. The ancestral matrix is leveraged to identify the source of the error and the micro-service associated with the identified error source.

In still another aspect, a computer program product is provided. The computer program product includes a computer readable storage medium having program code embodied therewith. The program code is executable by a processor to learn causal relationships between two or more application micro-services. Program code is provided to collect first micro-service error log data corresponding to one or more selectively injected errors and to generate a learned causal graph based on the collected first micro-service error log data. The learned causal graph represents dependency of application micro-services effected by the selective error injection. Program code is further provided to dynamically localize a source of an application error. Second micro-service error log data corresponding to the application error is collected and an ancestral matrix is built based on the learned causal graph and the collected second micro-service error log data. The ancestral matrix is leveraged to identify the source of the error and the micro-service associated with the identified error source.

In a further aspect, a computer-implemented method is provided for training an artificial intelligence model. First error log data corresponding to one or more selectively injected micro-service faults is collected and a causal graph is learned based on the collected error log data, which in an embodiment is referred to as first error log data. The causal graph represents dependency of effected application micro-services. An application fault is dynamically localized, which includes collecting second error log data corresponding to detection of the application fault. The second error log data and the learned causal graph are leveraged to identify a source of the application fault.

In a still further aspect, a computer system is provided with a processor operatively coupled to memory, and an artificial intelligence (AI) platform in communication with the processor and the memory. The AI platform includes a staging manager. A production manager is provided and operatively coupled to the AI platform. The staging manager is configured to train an AI model. First error log data corresponding to one or more selectively injected micro-service faults is collected and a causal graph is learned based on the collected first error log data. The causal graph represents dependency of effected application micro-services. The production manager, operatively coupled to the staging manager, is configured to dynamically localize an application fault. Second error log data corresponding to detection of the application fault is collected. The second error log data and the learned causal graph are leveraged to identify a source of the application fault.

These and other features and advantages will become apparent from the following detailed description of the exemplary embodiment(s), taken in conjunction with the accompanying drawings, which describe and illustrate various systems, sub-systems, devices, apparatus, models, processes, and methods of additional aspects.

### BRIEF DESCRIPTION OF THE SEVERAL VIEWS OF THE DRAWINGS

The drawings referenced herein form a part of the specification, and are incorporated herein by reference. Features shown in the drawings are meant as illustrative of only some embodiments, and not of all embodiments, unless otherwise explicitly indicated.

FIG. 1 illustrates a schematic diagram of a computer system to support and enable active learning in a staging environment to learn a causal graph, and to leverage the learned causal graph in the production environment to localize an application fault.

FIG. 2 illustrates a block diagram depicting the AI platform tools, as shown and described in FIG. 1, and their associated application program interfaces (APIs).

FIG. 3 illustrates a flow chart for learning a causal relationship among micro-services.

FIG. 4 illustrates a block diagram depicting an example intervention pattern.

FIG. 5 illustrates a block diagram depicting an example intervention matrix.

FIG. 6 illustrates a flow chart for using a transitive reduction causal graph from the output of FIG. 3 for fault localization in a production environment.

FIG. 7 illustrates a block diagram depicting an example of a computer system/server of a cloud based support system, to implement the system and processes described above with respect to FIGS. 1-6.

FIG. 8 illustrates a block diagram depicting a cloud computer environment.

FIG. 9 illustrates a block diagram depicting a set of functional abstraction model layers provided by the cloud computing environment.

### DETAILED DESCRIPTION

It will be readily understood that the components of the exemplary embodiments, as generally described and illustrated in the Figures herein, may be arranged and designed in a wide variety of different configurations. Thus, the following detailed description of the embodiments of the system, the computer program product, and the method and other aspect described herein, as presented in this description and the accompanying Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment. It should be understood that the various embodiments may be combined with one another and that embodiments may be used to modify one another.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

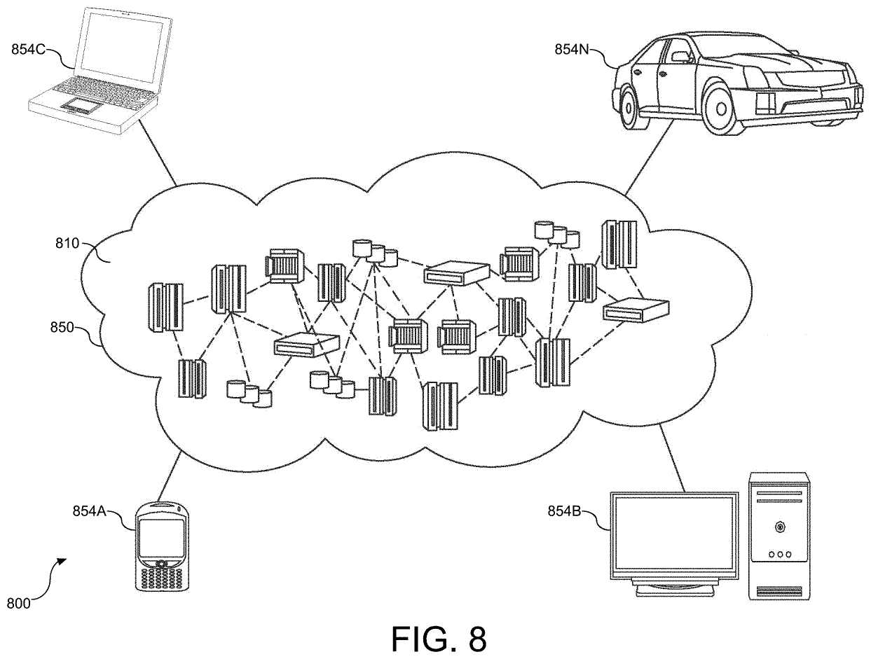

Cloud computer is on-demand access, via the Internet, to computing resources, such as applications, servers (including physical and virtual servers), data storage, development tools, and network capabilities hosted at a remote data center and managed by a cloud services provider. Software as a Service (SaaS), also known as cloud based software or cloud applications, is an example of application software that is hosted in the cloud and accessible via a web browser, a client machine, or an application program interface (API). Details of cloud computing are shown and described in FIG. 8. Micro-services or micro-service architecture are a cloud native architectural approach in which a single application is composed of many loosely coupled and independently deployable components or services. However, many cloud applications suffer from limited observability making it difficult to localize a fault in one or more application micro-services.

As shown and described herein, interventional causal learning is applied to one or more cloud applications in a pre-deployment environment, also referred to herein as a staging environment that is commonly used for software testing to assess quality before application deployment. The staging environment provides a venue for testing and assessment to mitigate errors during production, and as such is referred to herein as a pre-deployment environment. The staging environment serves as a venue for learning a causal model associated with application micro-services. A production environment describes a setting where the application is in operation for its intended purpose. More specifically, the production environment is a real-time setting where application execution occurs. As shown and described below, the production environment monitors error log data and leverages the learned causal model from the staging environment to accurately and efficiently localize an application fault with minimal observational data.

A causal model can be described as a graph, e.g. causal graph, of nodes and edges mapping cause and effect relationships. The causal graph is a directed acyclic graph (DAG) where an edge between two nodes encodes a causal relationship. In a directed graph the only edges are arrows, and an acyclic is a graph in which there is no feedback loop. Therefore, a DAG is a graph with only arrows for edges and no feedback loop, i.e. no node is its own ancestor or its own descendant. For example, X is a direct cause of Y, e.g. X→Y, such that forcing X to take a specific value effects the realization of Y. In causal diagrams, an arrow on the edge represents a direct effect of a parent node on a child node. A node that has no parent is referred to as a root or source node. A node with no children is referred to as terminal. A path or chain is a sequence of adjacent edges. In causal diagrams, directed paths represent causal pathways from a starting node to an ending node, e.g. from a parent node to a terminal node, and in an embodiment one or more intermediate nodes between the root and terminal nodes. Accordingly, the DAG represents a complete causal structure, in that all sources of dependence are explained by causal links.

As shown and described herein, a computer system, method, and computer program product are provided to employ fault injection to learn causal relationships between micro-services, and to leverage the learned causal relationships in real-time together with application error log data to identify and localize an application error source as directed to one or more application micro-services. Many cloud applications employ multiple micro-services. Industrial micro-service applications have hundreds or more micro-services and complex dependency relationships among them. The topology of the application micro-services is fixed, but often unknown. These applications have limited observability making localization of a fault in a corresponding micro-service or multiple micro-services difficult. The system, method, and computer program product shown and described herein use observational data in the form of error log data to identify a hidden causal graph or a subset of true causal edges among micro-services. The causal model is a mathematical model representing causal relationships within an individual system or population. As shown and described herein the computer system, computer program product, and computer-implemented method are provided to learn an accurate causal graph via interventional causal learning using a pre-deployment fault injection, and using the learning graph to perform affective and accurate fault localization.

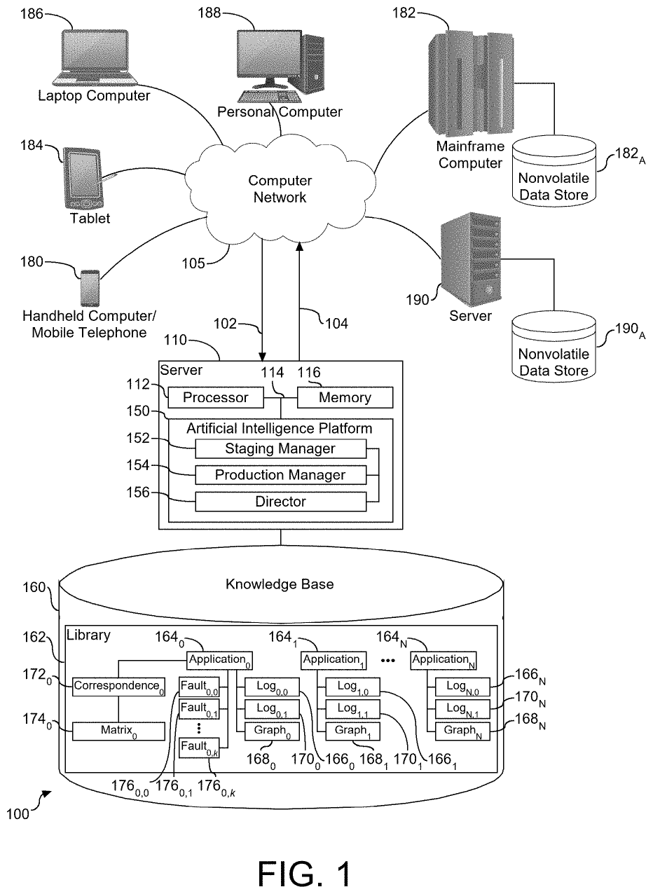

Referring to FIG. 1, a schematic diagram of a platform computing system (100) is depicted. In an exemplary embodiment, the system (100) includes or incorporates an artificial intelligence (AI) platform (150). As shown, a server (110) is provided in communication with a plurality of computing devices (180), (182), (184), (186), (188), and (190) across a network connection (105). The server (110) is configured with a processing unit (also referred to herein as a processor) (112) in communication with memory (116) across a bus (114). The server (110) is shown with the AI platform (150) for cognitive computing, including natural language processing (NLP) and machine learning (ML), over the network (105) from one or more of the computing devices (180), (182), (184), (186), (188), and (190). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The AI platform (150) is shown herein configured with tools to support active learning in a staging environment to learn a causal graph, and to leverage the learned causal graph in the production environment to localize a detected application fault. It is understood in the art that active learning is a form of machine learning. The tools include, but are not limited to, a staging manager (152), a production manager (154), and a director (156). Although FIG. 1 shows each of the tools (152), (154), and (156) as part of the AI platform (150), it should be understood that in an embodiment any one or combination of the tools (152), (154), and (156) is/are not necessarily part of the AI platform (150) or AI operated. In exemplary embodiments, the staging manager (152) is part of the AI platform (150) and the production manager (154) and/or director (156) are each non-AI, i.e., the production manager (154) and/or the director (156) are operatively coupled to the processor (112) and the AI platform (150), and the functions of the production manager (154) and/or director (156) are carried out without the use of artificial intelligence.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a dataset to solve problems and provide relevant recommendations. For example, in the field of AI computer systems, natural language systems (such as the IBM Watson® artificially intelligent computer system or other natural language interrogatory answering systems) process natural language based on system-acquired knowledge. To process natural language, the system may be trained with data derived from a database or corpus of knowledge.

Machine learning (ML), which is a subset of AI, utilizes algorithms to learn from data and create foresights based on this data. AI refers to the intelligence when machines, based on information, are able to make decisions, which maximizes the chance of success in a given topic. More specifically, AI is able to learn from a dataset to solve problems and provide relevant recommendations. Cognitive computing is a mixture of computer science and cognitive science. Cognitive computing utilizes self-teaching algorithms that use minimum data, visual recognition, and natural language processing to solve problems and optimize human processes.

At the core of AI and associated reasoning lies the concept of similarity. The process of understanding natural language and objects requires reasoning from a relational perspective that can be challenging. Structures, including static structures and dynamic structures, dictate a determined output or action for a given determinate input. More specifically, the determined output or action is based upon an express or inherent relationship within the structure. Adequate datasets are relied upon for building those structures.

The AI platform (150) is shown herein configured to receive input (102) from one or more sources. For example, the AI platform (150) may receive input (e.g., micro-service based application) across the network (105) from one or more of the plurality of computing devices (180), (182), (184), (186), (188), and (190). Furthermore, and as shown herein, the AI platform (150) is operatively coupled to a knowledge base (160). Although one knowledge base (160) is shown in FIG. 1, it should be understood that variations of the system (100) may be employed to support two or more knowledge bases in communication with the AI platform (150).

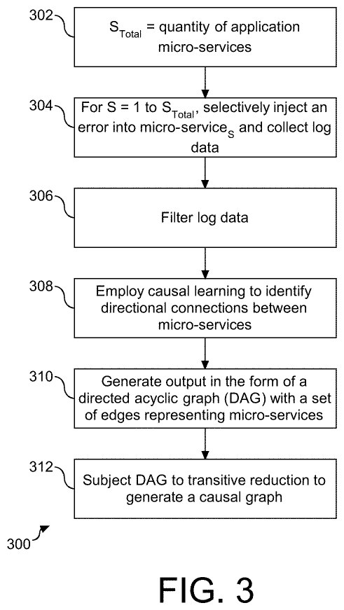

According to exemplary embodiments, the AI platform (150) is configured to learn causal relationships of application micro-services. The staging manager (152) is shown herein embedded within the AI platform (150). The staging manager (152) is configured to selectively inject one or more errors into application micro-services, collect corresponding application log data, subject the error log data to a filter or filtering process to identify log data corresponding to the injected one or more errors, and leverage the error log data to generate a causal graph, which is stored in the corresponding knowledge base (160). In an exemplary embodiment, the causal graph is an AI model, also referred to herein as a trained AI model. The process of creating the causal graph to be stored in the knowledge base (160) is shown and described in FIG. 3. The initial aspect of causal learning is directed at error injection into application micro-services. Errors are injected into the application micro-services by the staging manager (152). The errors may be injected individually, e.g. one micro-service at a time, or into sets of micro-services, e.g. two or more micro-services at a time. In an embodiment, the errors may be injected randomly. Similarly, in an embodiment, the error injection may follow a pattern. Error injection is directed at creating a problem associated with functionality of application micro-services. For example, an error injection may be in the form of blocking a specific micro-service, slowing down operability of the micro-service, or otherwise making the micro-service unavailable to the application.

An error log is a record of errors that are encountered by the application, operating system, or server while in operation. For example, some common entries in an error log include table corruption and configuration corruption. Error logs may capture an abundant quantity of information, which in an embodiment may include relevant or irrelevant data. The staging manager (152) addresses this aspect by subjecting the log data to pre-processing to identify the error logs corresponding to or associated with the injected error(s). In an exemplary embodiment, the staging manager (152) filters the log data to extract specific message text associated with the injected error(s). An example of a filter may be in the form of, but not limited to, one or more keywords or a combination of keywords in the error logs. Application of a filter provides a focus on relevant log data, also referred to herein as error log data. The staging manager (152) collects, or otherwise identifies or obtains, the error logs that remain after the pre-processing to learn causal relationships among the application micro-services, also referred to herein as causal learning. Details of the causal learning is shown and described in detail in FIGS. 3-5. The causal learning effectively calculates a correspondence between a micro-service subject to an injected fault and each related micro-service to ascertain which micro-services are or were effected by the fault injection. More specifically, the causal learning identifies directional connections between micro-services. In an exemplary embodiment, the causal learning creates output in the form of a set of micro-services represented in a DAG, with the set of represented micro-services related to the log data that emitted or otherwise captured or documented one or more errors. Accordingly, the staging manager generates a causal graph of application micro-services from error log data.

The staging manager (152) employs the output of the set of micro-services to generate or otherwise construct a corresponding casual graph, e.g. DAG. More specifically, directed edges between two micro-services are selectively removed from the set of micro-services. In an exemplary embodiment, the selective removal filters out a selection of one or more edges through transitive reduction. Details of the selective removal are shown and described in FIG. 3. The DAG is generated, or in an embodiment re-generated, from the set of micro-services remaining in the set of micro-services. Accordingly, a causal graph of micro-services is generated from a reduced set of the effected micro-services, which in an embodiment is a subset of application micro-services.

As shown herein, the knowledge base (160) is shown with a library (162) configured to receive and store the generated causal graph(s). Although only one library is shown, in an embodiment, the knowledge base (160) may include one or more additional libraries. By way of example, the library (162) is shown with a plurality of applications, each application having a first error log and a corresponding causal graph. As shown herein by way of example, the library (162) is shown with three applications, including application₀ (164₀), application₁ (164₁), and application_{N} (164_{N}). Although only three applications are shown, the quantity is for illustrative purposes and should not be considered limiting. Each application has a corresponding first error log, shown herein as log₀ (166₀), log₁ (166₁), and log_{N} (166_{N}), and a corresponding causal graph, shown herein as graph₀ (168₀), graph₁ (168₁), and graph_{N} (168_{N}).

User flow is referred to as a path taken by a prototypical user on an application to complete a task. The user flow takes the user from their entry point through a set of steps towards a successful outcome and final action, such as purchasing a product. Confounding is a causal concept defined in terms of a data generating model. A confounder is a variable that influences both the dependent variable and independent variable. As shown and described herein, the staging manager (152) addresses unobserved confounding due to user flows by inferring a causal graph from error log data.

The staging manager (152), which is shown in FIG. 1 as part of the AI platform (150) but in an alternative exemplary embodiment is not AI-based or part of the AI platform (150), is configured to generate a causal graph between application micro-services. A causal effect means that something has happened, or is happening, based on something that has occurred or is occurring. With respect to micro-services, an error on a first micro-service, A, may cause an error in a second micro-service, B. This could be represented in a directed edge from A to B, e.g. AB. However, if micro-service B does not receive or experience an error from an error on micro-service A, then there is no directed edge from A to B.

The staging manager (152) and its functionality of causal graph generation from the error log associated with the selective error injection, functions offline. In an embodiment, the error log data associated with an application and generated by the staging manager (152) is referred to herein as first error log data. The production manager (154) is provided to support online processing, and more specifically, to localize an error source. In an embodiment, the production manager (154) is operatively coupled to the AI platform (150). Similarly, in an embodiment, the production manager (154), and its functionality, takes place in real-time as a dynamic component. Similar to the staging environment associated with the functionality of the staging manager (152), error log data associated with application processing and execution is collected by the production manager (154). In an embodiment, the error log data associated with the production manager (154) is referred to herein as second error log data. As shown herein by way of example, the second error log data is stored in the knowledge base (160) and shown herein as (170₀), (170₁), and (170_{N}), with each second error log data associated with processing of the corresponding application (164₀), (164₁), and (164_{N}). The difference between the first and second error log data lies in the manner in which the error log data is generated. The staging manager (152) operates offline, and intentionally injects one or more errors into application micro-services, with the first error log data providing documentation of the effect(s) of the error injection(s). Whereas the production manager (154) operates online and the generated second error log data provides documentation of the effect(s) of application processing error(s). Accordingly, the staging manager (152) artificially creates the micro-service fault(s), and the production manager (154) responds to application errors detected during application processing and execution.

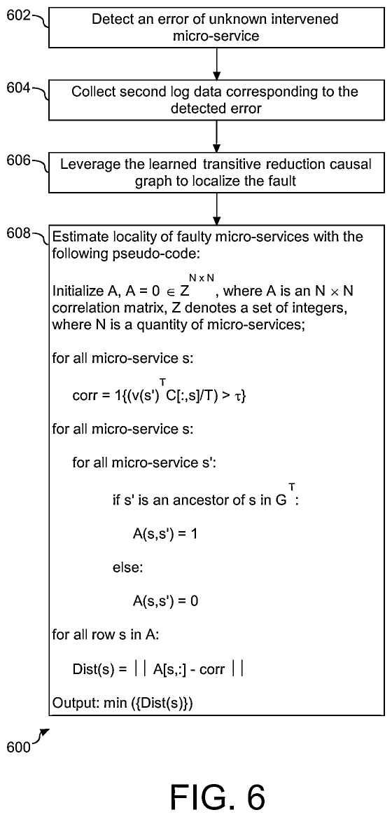

The error log data collected by the production manager (154) takes place in real-time. The production manager (154) leverages the collected second error log data to calculate a correspondence between the micro-service that is the subject of the fault and other application micro-services, and leverage a corresponding causal graph associated with first error log data and stored in the knowledge base (160), to generate an ancestral matrix. With respect to application₀ (164₀), the calculated correspondence is shown herein as (172₀). Details of the process of generating the ancestral matrix are shown and described in FIG. 3. By way of example, an assessment of application₀ (164₀) using the corresponding causal graph (168₀) generates the ancestral matrix (174₀). Using the ancestral matrix (174₀) and the calculated correspondence (172₀), the production manager (154) employs a metric function to assess similarity between strings, to compare the ancestral matrix, e.g. (174₀), with respect to the correspondence, e.g. (172₀), calculated by the production manager (154). In an embodiment, the metric function is a Hamming distance or a cosine similarity. Details of the fault localization are shown and described in FIG. 6. In an exemplary embodiment, the metric function yields an estimated location of the fault and produces a top-k list of possible fault locations, where k is a configurable value. Accordingly, the production manager (154) applies fault localization on a learned causal graph, and employs the thresholding distance to estimate or otherwise identify the fault location.

The director (156) is shown herein operatively coupled to the production manager (154). The director (156) identifies or recommends one or more faulty micro-services as the source of the detected error based on the assessment. In an exemplary embodiment, the director (156) communicates the one or more faulty micro-services to a subject matter expert (SME) for remediation.

As shown herein, the staging manager (152) learns causal relationships, and stores a representation of the learned causal relationships, referred to herein as a causal graph, in the knowledge base (160). The production manager (154), which is in communication with the knowledge base (160), uses the learned causal graph and second log data to determine the top-k list of possible fault locations for a given application fault. In an embodiment, the director (156) stores the possible application fault locations, e.g. micro-services, in the knowledge base (160). As shown herein by way of example, application (164₀) is shown with possible fault locations (176_{0,0}), (176_{0,1}), . . . , (176_{0,k}). The fault locations shown herein are directed to application₀ (164₀). Although not shown, in an embodiment, application₁ (164₁) and/or application_{N} (164_{N}) may have a list or group of possible fault locations. On the other hand, the director (156) may be configured not to further populate the knowledge base (160) with the top-k list of possible fault locations.

In some illustrative embodiments, the server (110) may be the IBM Watson® system available from International Business Machines Corporation of Armonk, N.Y., which is augmented with the mechanisms of the illustrative embodiments described hereafter. The staging manager (152), the production manager (154), and the director (156), referred to collectively as tools, are shown as being embodied in or integrated within the AI platform (150) of the server (110). In an embodiment, the staging manager (152) is embodied in the AI platform (150), and the production manager (154) and the director (156) are operatively coupled to the AI platform (150). In another embodiment, the tools may be implemented in a separate computing system (e.g., server 190) that is connected across network (105) to the server (110). Wherever embodied, the tools function to support identifying causal pairs of application micro-services, and to leverage the identified causal pairs to dynamically localize a fault.

Types of information handling systems that can utilize the AI platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various information handling systems can be networked together using computer network (105). Types of computer network (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes nonvolatile data store (190_{A}), and mainframe computer (182) utilizes nonvolatile data store (182a). The nonvolatile data store (182_{A}) can be a component that is external to the various information handling systems or can be internal to one of the information handling systems.

The information handling system employed to support the AI platform (150) may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, the information handling system may embody the north bridge/south bridge controller architecture, although it will be appreciated that other architectures may also be employed.

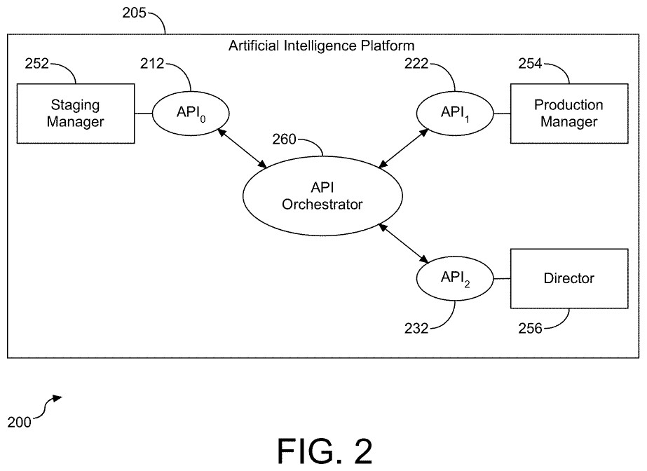

An Application Program Interface (API) is understood in the art as a software intermediary between two or more applications. With respect to the (AI) platform (150) shown and described in FIG. 1, one or more APIs may be utilized to support one or more of the tools (152), (154), and (156) and their associated functionalities. Referring to FIG. 2, a block diagram (200) is provided illustrating the tools (152), (154), and (156) and their associated APIs. As shown, a plurality of tools is embedded within the (AI) platform (205), with the tools including a staging manager (252) associated with API₀ (212), a production manager (254) associated with API₁ (222), and a director (256) associated with API₂ (232). Each of the APIs may be implemented in one or more languages and interface specifications.

As shown, API₀ (212) is configured to support an offline task of selectively injecting errors into application micro-service(s), and processing corresponding error logs, also referred to herein as first error log data, to generate or otherwise learn a causal graph. API₁ (222) provides functional support to an on-line task for collecting all micro-service error log data, also referred to herein as second error log data, corresponding to an application error and building an ancestral matrix based on the learned causal graph. API₂ (232) provides functional support for fault localization, which in an embodiment includes application of a metric function to assess similarity between strings and to leverage the assessment together with an associated ancestral matrix to identify a sub-set of micro-services, e.g. top-k, that are or may be the source of the detected error. As shown, each of the APIs (212), (222), and (232) are operatively coupled to an API orchestrator (260), otherwise known as an orchestration layer, which is understood in the art to function as an abstraction layer to transparently thread together the separate APIs. In an embodiment, the functionality of the separate APIs may be joined or combined. In another embodiment, the functionality of the separate APIs may be further divided into additional APIs. As such, the configuration of the APIs shown herein should not be considered limiting. Accordingly, as shown herein, the functionality of the tools may be embodied or supported by their respective APIs.

Referring to FIG. 3, a flow chart (300) is provided to illustrate a process for learning a causal relationship among micro-services. The initial aspect of learning the causal relationships includes identifying application micro-services through selective and controlled fault injection. As shown herein, the variable S_{Total} represents the quantity of application micro-services (302). For each of the represented micro-services, e.g. from S=1 to S_{Total}, an error is selectively injected and corresponding log data is collected (304). In an embodiment, injecting an error may be blocking, removing, or delaying micro-service_{S}. The selective error injection at step (304) may be applied to micro-services individually or in combination, e.g. two or more micro-services may be the subject of the fault injection. It is understood in the art that there are various faults or errors that may be applied to the micro-services. In an embodiment, the form or type of error(s) injection at step (304) is randomly selected for application to the one or more micro-services. Similarly, in an exemplary embodiment, the fault injection at step (304) is controlled or is supported by a pattern of error injections. Accordingly, the initial aspect of learning the causal relationship among application micro-services is directed at selective error injection directed at one or more micro-services.

Error propagation is a term that refers to the way in which, at a given stage of calculation, part of an error arises out of the error at a previous stage. In the micro-service architecture, and more specifically, the dependency relationships among the micro-services, an error introduced in one micro-service may extend uncertainty into one or more related micro-services. As errors are injected, corresponding application log data is collected. It is understood in the art that log data is an automatically produced and time-stamped documentation of events. With respect to an application and its embedded micro-services, and more specifically with respect to the micro-service(s) error injection, the log data identifies a direct or indirect effect of the injected error on other application micro-services that have not directly been subject to the error injection. In an embodiment, the log data is a log file recording messages associated with the functionality of one or more micro-services, including one or more micro-services effected by the fault injected micro-service(s), and in an embodiment one or more micro-services not effected by the injected fault. In an exemplary embodiment, the log file is utilized for error tracing associated with the injected fault. Accordingly, the error injection artificially creates a problem in the application micro-service architecture, and the log file documents log data of one or more micro-service(s) concerns as related to the injected error.

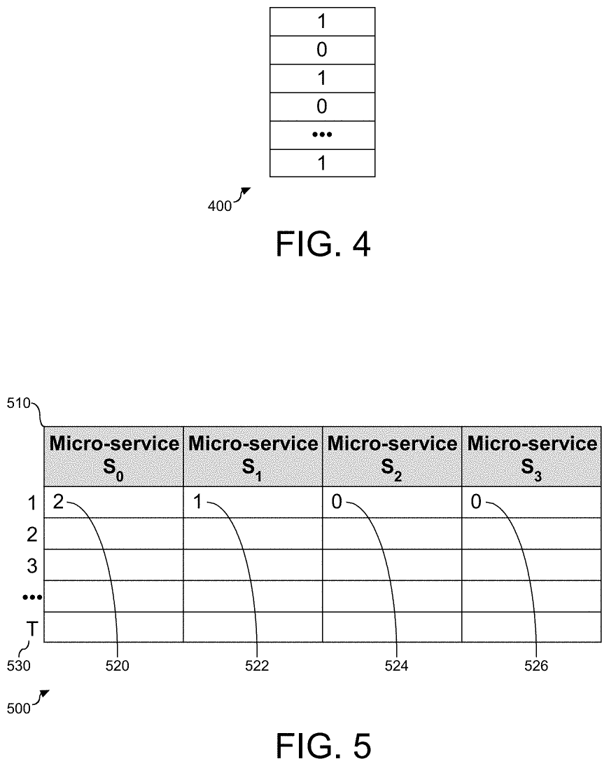

It is understood in the art that log files are comprised of a plurality of messages containing text and corresponding timestamps. Some of the messages or message content may contain irrelevant or extraneous information in relation to the injected error. For example, log data may include a message, e.g. error message, that a particular micro-service may not be able to process a request in response to a fault injected into a different application micro-service. To address the log files, and in an embodiment an abundant quantity of log data, the log files and corresponding log data collected at step (304) are subject to processing or pre-processing to filter out, e.g. remove, log data that is irrelevant to the injected error(s) (306). In an embodiment, one or more defined keywords are applied to the log file as a filter to extract relevant or useful log data, which in an embodiment returns all the error logs. In an exemplary embodiment, a sub-set of the original log data remains after the filtering step, and micro-services related to the sub-set of the log data are the subject of the causal learning. Following step (306), causal learning through intervention patterns is employed to identify directional connections between micro-services that are the subject to the log data that survived the pre-processing (308). Details of the causal learning are shown and described in FIGS. 4 and 5. In an embodiment, causal learning is a form of machine learning that employs causal reasoning. At step (308), the causal learning includes learning a correlation score between micro-services based on an intervention pattern and a corresponding intervention matrix, and representation of a learned causal graph using transitive reduction. The correlation score assessment at step (308) identifies the strength of a correspondence between the micro-service that is the subject of the fault, s′, and a micro-service(s) identified from the subset of the log data. As shown and described in FIG. 4, the correlation score is assessed with respect to a configurable threshold. The assessment from step (308) generates output in the form of a DAG comprised of a set of edges that surpassed the correlation score assessment, with each edge representing the micro-service that is the subject of the fault and an effected micro-service (310). In an exemplary embodiment, and as shown herein, the graph generated at step (310) is subject to a transitive reduction to selectively remove one or more edges and generate a casual graph (312). Transitive reduction is an edge-removing operation on directed graphs that preserves some important properties and structure of the graph. The transitive reduction is used to preserve important structural properties of the learned causal graph and build the ancestry of learned causal graph for localizing faulty services. Details of the transitive reduction are shown and described in detail below. Accordingly, the log data associated with the fault injection is leveraged as a source to generate the causal graph.

Referring to FIG. 4, a block diagram (400) is provided to illustrate an example intervention pattern. The vector v(s′) is an intervention pattern vector of micro-service s′, where s′ is the micro-service that is the subject of the injected fault. In an embodiment and as described herein by way of example, the aspect of the fault injection may be in the form of blocking the micro-service from performing its intended function. The vector v(s′)ₜ represents how other micro-services in the application are effected by the blocked micro-service, s′, at time bin t. As shown in this example, entries in the vector are in bit form, 0's and 1's. In an embodiment, an entry of 0 in the vector indicates that the micro-service is unaffected by the blocked micro-service, and an entry of 1 in the vector indicates that the micro-service is effected, e.g. experiencing an error. Similarly, in an embodiment, the representation of the vector entries may be reversed, and as such, the entry representation should not be considered limiting. The vector shown herein is directed at the fault injected micro-service, s′, across time bins, t, and documents a reaction of application micro-services to the fault injection. A plurality of the vectors is utilized to generate a corresponding intervention matrix, C. An example intervention matrix is shown and described in FIG. 5. In an exemplary embodiment, the strength of a correlation between micro-service s′ and all other micro-services is assessed as follows:

con(s′,s)=v(s′)^{T}C[:,s]/T≈E[I(intervention s′)count of error logs]

where corr (s′, s) is a correlation score of micro-service s' and micro-service s, v(s′) is an intervention pattern vector of micro-service s′, v(s′)^{T} is a transpose of vector v(s′), and C[:,s] is a column of micro-service s in the intervention matrix C. Accordingly, a set of micro-services, S, related to the fault injected micro-service, s′, that are the subject of the processed error logs and emitted one or more errors, are evaluated based on a correspondence assessment to selectively populate and form the generated causal graph.

Referring to FIG. 5, a block diagram (500) is provided to illustrate an example intervention matrix (510). As shown, the intervention matrix, C(s′), is directed at the fault injected micro-service, s′. As shown in this example, there are five micro-services. One of the micro-services, s′, is injected with an error or fault, and the remaining four micro-services s₀, s₁, s₂, and s₃ are either effected or unaffected by the injected error. As shown herein by way of example, at time period t=1, micro-service s₀ is shown with two errors at (520), micro-service s₁ is shown with one error at (522), and each of micro-service s₂ and s₃ are shown with no errors at (524) and (526), respectively. The intervention matrix, C, is shown to include multiple time periods (530), also referred to herein as time bins, T. Accordingly, C(s′) is an intervention matrix formed from multiple intervention pattern vectors with the intervention matrix indicating a reaction of all micro-services effected by the fault injection micro-service, s′.

For a DAG with individual nodes representing a micro-service and a directional edge representing ancestral relationships between nodes, the causal learning at step (310) includes estimating ancestral edges for a node in a DAG with a fault injection (312). As shown and described in FIG. 1, the correlation assessment occurs in the production environment and is managed by the production manager (154). The following pseudo-code demonstrates estimation of correlation of ancestral edges associated with dependency of micro-services:

For all s′ which are intervened

Filter logs under s′—C,v(s′)

corr(s′,s)>τ,E=E+(s′,s)

Output transitive_reduction(E)//output the learned causal graph// where C is the intervention matrix showing other micro-services, e.g. s₀, s₁, s₂, and s₃, effected by the fault injected into micro-service s′, as shown in FIG. 5, and E is a set of tuples of directed edges between micro-services that emitted errors during application processing. The intervention matrix is a compilation of intervention pattern vectors v(s′). As shown herein, the correlation score between micro-services s′ and s is learned and assessed against a threshold value for a correlation score τ, which in an embodiment is a tunable threshold. For example, if the correlation score, corr (s′, s)>τ, it is an indication that micro-service s′ and micro-service s have a strong correlation. Transitive reduction is an edge removing operation on a directed graph that preserves some important properties and structure of the graph. The output from the ancestral edge estimation at step (312) is a causal graph. The process of error injection to one or more select micro-services as shown herein is referred to as a pre-deployment fault injection stage. In an embodiment, the set of causal edges in the learned causal graph as shown herein is theoretically guaranteed to only contain a set or subset of true causal edges with a high probability of causal relation. Accordingly, the causal graph is generated based on log data information collected through use of one or more fault injections.

The estimated ancestral edges from various fault injections are combined into a succinct representation by performing transitive reduction (314) to ensure that only a subset of true causal edges that preserve ancestry are in the representation. Transitive reduction of a directed graph, G, is another directed graph G′ with same quantity of vertices and the smallest number of edges as possible, such that for all pair of vertices a path between vertices in G exits if and only if such as path exists in G′. The following pseudo-code demonstrates the transitive reduction as applied to the causal graph E:

def transitive_reduction (E):
construct G=(V,E) with input E
for any directed edge pair (a,b) in E:
   if node a can reach node b when E−{(a,b)}:

G=(V,E−{(a,b)})
return G
   where G represents a re-generated causality graph of micro-services with (a,b) removed from the set of directed edges E. In an embodiment, the steps shown and described herein may be performed offline. Accordingly, transitive reduction is used to identify a succinct representation of a learned causal graph representing dependency of a subset of micro-services related to the fault injected micro-service, s′.

Referring to FIG. 6, a flow chart (600) is provided to illustrate using the transitive reduction causal graph from the output of FIG. 3 for fault localization in a production environment. In an exemplary embodiment, the fault localization described herein is performed in real-time. An error of an unknown intervened micro-service is detected (602) and all log data corresponding to the detected error, also referred to herein as second log data, is collected (604). In an exemplary embodiment, the collection of the second log data takes place in real-time. Following the second error log collection, the learned transitive reduction causal graph, G, from the staging environment is leveraged to localize the fault (606). The following pseudo code demonstrates estimating the locality of the faulty micro-service (608):
Initialize A=0∈Z^{N×N} where A is a N*N correlation matrix, Z denotes a set of integers, where N is a quantity of micro-services;
for all micro-service s:

corr=1{v(s′)^{T}C[:,s]/T)>τ}
for all micro-service s: //build the correlation matrix, A, based on the learned causal graph//
   for all micro-service s′:
      if s′ is an ancestor of s in G^{T}:

A(s,s′)=1
else:

A(s,s′)=0
for all row s in A

Dist(s)=∥A[s,:]−corr∥//Distance assessment//Output: min({Dist(s)})//returns the faulty micro-service(s)//

where G^{T} is the transitive reduction of learned causal graph G. The correlation assessment shown in the pseudo-code uses an identical function, e.g. 1{⋅}. By way of example, if corr=[0.8 0.1 0.1 0.9 0.1 0.2 . . . ]∈Z^{N×1} and τ=0.3, then 1{0.8>0.3}=1 and 1{0.1<0.3}=0. Based on this example, 1{corr}=[1 0 0 1 0 0 . . . ]∈Z^{N×1}. The distance assessment, Dist(s), leverages the correlation matrix A to measure the distance between rows. In an embodiment, the rows of the correlation matrix A each have entries in the form of bits, with 1 representing the micro-service having an ancestor in the learned causal graph and 0 representing the inverse, e.g. no ancestor in the learned causal graph. The distance assessment represents the number of points in which the two corresponding pieces of data are different. In an embodiment, the distance assessment may employ by in the form of a Hamming distance or a cosine similarity. In an exemplary embodiment, the metric function yields an estimated location of the fault and produces a top-k list of possible fault locations, where k is a configurable value. Accordingly, as shown herein the correlation matrix, A, is built based on the learned causal graph, G, and the location of the fault is estimated using a distance assessment.

The processes shown and described in FIGS. 3 and 6 illustrate a scenario that faults are injected, either planned or unplanned, respectively, in a single micro-service. In an embodiment, these processes may be extended to injecting faults in pairs or in a subset of micro-services. Similarly, in an embodiment, the process shown and described in FIG. 6 may be extended to a full causal graph instead of a transitive reduction graph. As shown herein, the fault localization includes building an ancestral matrix, A, based on the learned causal graph, G, and estimating the location of the fault using a distance assessment. In an exemplary embodiment, a plurality of estimated fault locations, e.g., top k, may be produced from the fault localization process. Accordingly, log data is accumulated and processed as a source for learning the causal graph, G, using a pre-deployment fault injection system, which is then used in real-time to dynamically and effectively perform fault localization.

Certain exemplary embodiments of the systems, methods, and computer program products described herein produce high quality collections of cause-effect pairs in an automated, substantially or entirely unsupervised manner. Exemplary embodiments further involve the use of the cause-effect pairs for further processing, representation as a causal knowledge graph, and use for decision support or predictive analysis.

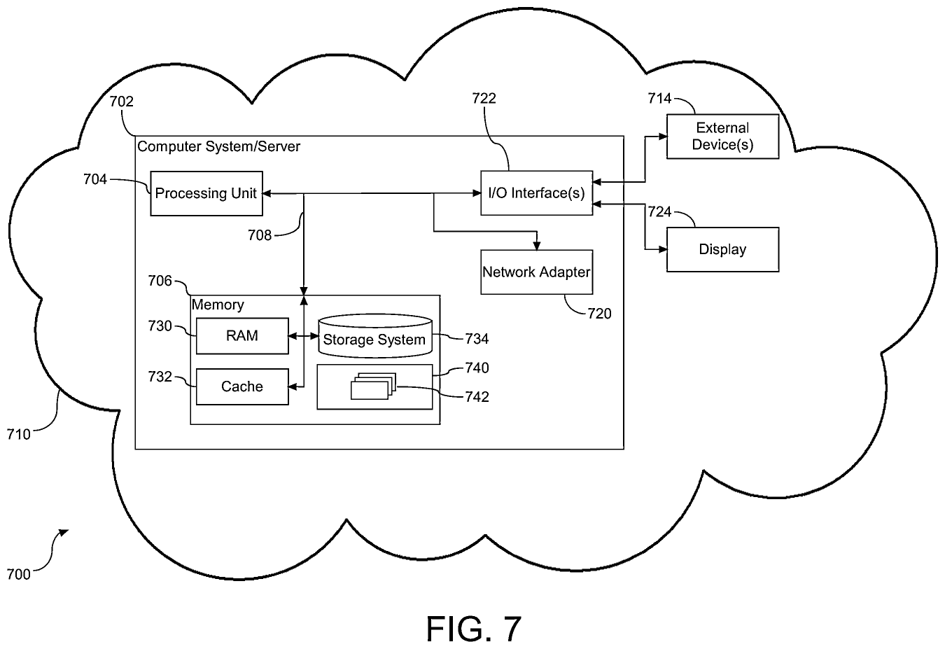

Aspects of identifying and verifying causal pairs are shown and described with the tools and APIs shown in FIGS. 1 and 2, respectively, and the processes shown in FIGS. 3 and 6. Aspects of the functional tools (152), (154), and (156) and their associated functionality may be embodied in a computer system/server in a single location, or in an embodiment, may be configured in a cloud-based system sharing computing resources. With references to FIG. 7, a block diagram (700) is provided illustrating an example of a computer system/server (702), hereinafter referred to as a host (702) in communication with a cloud-based support system, to implement the processes described above with respect to FIGS. 3 and 6. The host (702) is operational with numerous other general purpose or special purpose computing system environments or configurations. Examples of well-known computing systems, environments, and/or configurations that may be suitable for use with the host (702) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The host (702) may be described in the general context of computer system-executable instructions, such as program modules, being executed by a computer system. Generally, program modules may include routines, programs, objects, components, logic, data structures, and so on that perform particular tasks or implement particular abstract data types. Host (702) may be practiced in distributed cloud computing environments (710) where tasks are performed by remote processing devices that are linked through a communications network. In a distributed cloud computing environment, program modules may be located in both local and remote computer system storage media including memory storage devices.

As shown in FIG. 7, the host (702) is shown in the form of a general-purpose computing device. The components of the host (702) may include, but are not limited to, one or more processors or processing units (704), e.g. hardware processors, a system memory (706), and a bus (708) that couples various system components including the system memory (706) to the processing unit (704). A bus (708) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The host (702) typically includes a variety of computer system readable media. Such media may be any available media that is accessible by the host (702) and it includes both volatile and non-volatile media, removable and non-removable media.

The system memory (706) can include computer system readable media in the form of volatile memory, such as random access memory (RAM) (730) and/or cache memory (732). By way of example only, a storage system (734) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus (708) by one or more data media interfaces.

A program/utility (740), having a set (at least one) of program modules (742), may be stored in the system memory (706) by way of example, and not limitation, as well as an operating system, one or more application programs, other program modules, and program data. Each of the operating systems, one or more application programs, other program modules, and program data or some combination thereof, may include an implementation of a networking environment. The program modules (742) generally carry out the functions and/or methodologies of embodiments to support and enable active learning through selective fault injection for causal graph generation, and leveraging the output of the active learning for dynamic fault localization. For example, the set of the program modules (742) may include the tools (152), (154), and (156) as described in FIG. 1.

The host (702) may also communicate with one or more external devices (714), such as a keyboard, a pointing device, etc.; a display (724); one or more devices that enable a user to interact with the host (702); and/or any devices (e.g., network card, modem, etc.) that enable the host (702) to communicate with one or more other computing devices. Such communication can occur via Input/Output (I/O) interface(s) (722). Still yet, the host (702) can communicate with one or more networks such as a local area network (LAN), a general wide area network (WAN), and/or a public network (e.g., the Internet) via a network adapter (720). As depicted, the network adapter (720) communicates with the other components of the host (702) via the bus (708). In an embodiment, a plurality of nodes of a distributed file system (not shown) is in communication with the host (702) via the I/O interface (722) or via the network adapter (720). It should be understood that although not shown, other hardware and/or software components could be used in conjunction with the host (702). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as the system memory (706), including the RAM (730), the cache (732), and the storage system (734), such as a removable storage drive and a hard disk installed in a hard disk drive.

Computer programs (also called computer control logic) are stored in the system memory (706). Computer programs may also be received via a communication interface, such as the network adapter (720). Such computer programs, when run, enable the computer system to perform the features of the present embodiments as discussed herein. In particular, the computer programs, when run, enable the processing unit (704) to perform the features of the computer system. Accordingly, such computer programs represent controllers of the computer system.

In an embodiment, the host (702) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 8, an illustrative cloud computing network (800) is shown. The cloud computing network (800) includes a cloud computing environment (850) having one or more cloud computing nodes (810) with which local computing devices used by cloud consumers may communicate. Examples of these local computing devices include, but are not limited to, a personal digital assistant (PDA) or a cellular telephone (854A), a desktop computer (854B), a laptop computer (854C), and/or automobile computer system (854N). Individual nodes within the cloud computing nodes (810) may further communicate with one another. They may be grouped (not shown) physically or virtually, in one or more networks, such as Private, Community, Public, or Hybrid clouds as described hereinabove, or a combination thereof. This allows the cloud computing environment (800) to offer infrastructure, platforms and/or software as services for which a cloud consumer does not need to maintain resources on a local computing device. It is understood that the types of computing devices (854A-N) shown in FIG. 8 are intended to be illustrative only and that the cloud computing environment (850) can communicate with any type of computerized device over any type of network and/or network addressable connection (e.g., using a web browser).

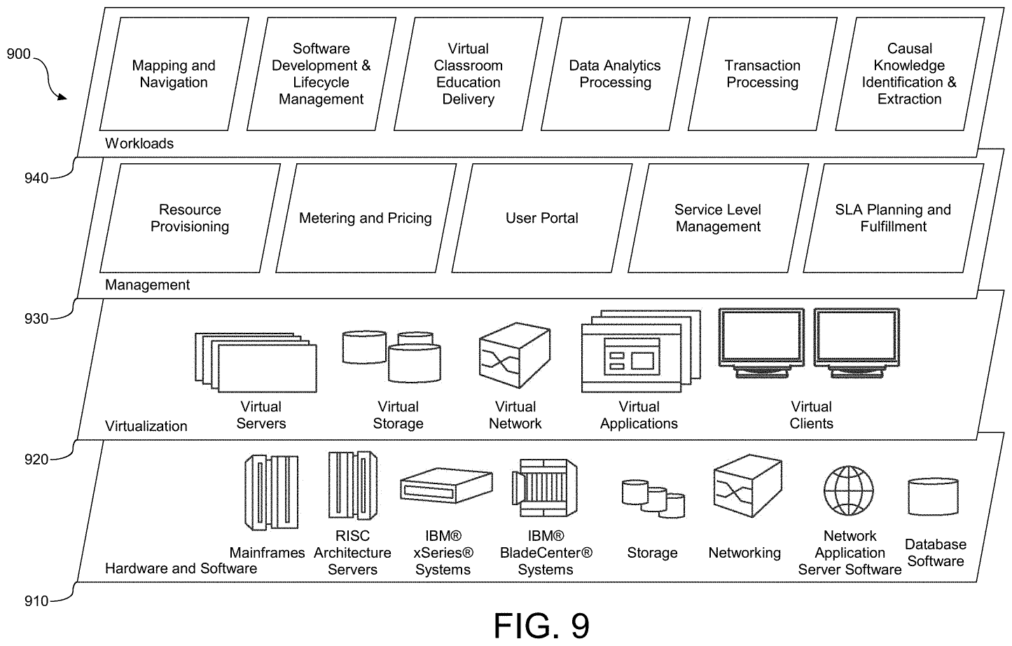

Referring now to FIG. 9, a set of functional abstraction layers (900) provided by the cloud computing network of FIG. 8 is shown. It should be understood in advance that the components, layers, and functions shown in FIG. 9 are intended to be illustrative only, and the embodiments are not limited thereto. As depicted, the following layers and corresponding functions are provided: a hardware and software layer (910), a virtualization layer (920), a management layer (930), and a workload layer (940).

The hardware and software layer (910) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

The virtualization layer (920) provides an abstraction layer from which the following examples of virtual entities may be provided: virtual servers; virtual storage; virtual networks, including virtual private networks; virtual applications and operating systems; and virtual clients.

In one example, the management layer (930) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

The workloads layer (940) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and causal knowledge identification and extraction.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles. As used herein, the term “and/or” means either or both (or any combination or all of the terms or expressed referred to), e.g., “A, B, and/or C” encompasses A alone, B alone, C alone, A and B, A and C, B and C, and A, B, and C.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product are operative to provide improvements to identifying and verifying causal pairs.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Additional blocks not represented in the Figures may be included, for example, prior to, subsequent to, or concurrently with one or more illustrated blocks. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. In particular, identifying and verifying causal pairs may be carried out by different computing platforms or across multiple devices. Furthermore, the data storage and/or corpus may be localized, remote, or spread across multiple systems. Accordingly, the scope of protection of the embodiments is limited only by the following claims and their equivalents.

What is claimed is:

1. A computer system comprising:
a computer processor operatively coupled to memory;
an artificial intelligence (AI) platform in communication with the computer processor and memory, the AI platform comprising:
a staging manager configured to learn causal relationships between two or more application micro-services, including:
collect first micro-service error log data corresponding to one or more selectively injected errors; and
generate a learned causal graph based on the collected first micro-service error log data, the learned causal graph representing dependency of application micro-services effected by the selective error injection;
a production manager operatively coupled to the staging manager, the production manager configured to dynamically localize a source of an application error, including:
collect second micro-service error log data corresponding to the application error;
build an ancestral matrix based on the learned causal graph and the collected second micro-service error log data; and
leverage the ancestral matrix to identify the source of the error; and
a director, operatively coupled to the production manager, configured to identify the micro-service associated with the identified error source.

2. The computer system of claim 1, wherein the causal relationship learning between two or more application micro-services, further comprises the staging manager to filter the collected first micro-service error log data to selectively remove a subset of first error log data.

3. The computer system of claim 1, wherein the causal relationship learning between application micro-services and the causal graph generation occurs offline.

4. The computer system of claim 1, wherein fault localization occurs online in real-time.

5. The computer system of claim 1, further comprising the staging manager configured to apply transitive reduction to the learned causal graph.

6. The computer system of claim 1, wherein the leverage of the ancestral matrix includes the production manager to identify a plurality of potential sources of the error, and further comprising the production manager configured to apply a distance metric to estimate the error source, wherein the distance metric comprises a Hamming distance or cosine similarity.

7. A computer-implemented method comprising:
learning causal relationships between two or more application micro-services, including:
collecting first micro-service error log data corresponding to one or more selectively injected errors; and
generating a learned causal graph based on the collected first micro-service error log data, the learned causal graph representing dependency of micro-services effected by the selective error injection; and
dynamically localizing a source of an application error, including:
collecting second micro-service error log data corresponding to the application error;
building an ancestral matrix based on the learned causal graph and the collected second micro-service error log data; and
leveraging the ancestral matrix to identify the source of the error; and
identifying the micro-service associated with the identified error source.

8. The method of claim 7, wherein learning causal relationships between two or more application micro-services further comprises filtering the collected first micro-service log data to selectively remove a subset of first error log data.

9. The method of claim 7, wherein learning causal relationships between two or more application micro-services and generating the causal graph occurs offline.

10. The method of claim 7, wherein fault localization occurs online in real-time.

11. The method of claim 7, further comprising applying transitive reduction to the learned causal graph.

12. The method of claim 7, wherein leveraging the ancestral matrix identifies a plurality of potential sources of the error, and further comprising applying a distance metric to estimate the error source, wherein the distance metric comprises a Hamming distance or cosine similarity.

13. A computer program product comprising;
a computer readable storage device; and
program code embodied with the computer readable storage device, the program code executable by the processor to:
learn causal relationships between two or more application micro-services, including:
collect first micro-service error log data corresponding to one or more selectively injected errors; and
generate a learned causal graph based on the collected first micro-service error log data, the learned causal graph representing dependency of micro-services effected by the selective error injection; and
dynamically localize a source of an application error, including:
collect second micro-service error log data corresponding to the application error;
build an ancestral matrix based on the learned causal graph and the collected second micro-service error log data; and
leverage the ancestral matrix to identify the source of the error; and
identify the micro-service associated with the identified error source.

14. The computer program product of claim 13, wherein the program code to learn causal relationships between two or more application micro-services further comprises program code to filter the collected first micro-service log data to selectively remove a subset of first error log data.

15. The computer program product of claim 13, wherein the program code to learn causal relationships between application micro-services and generate the causal graph occurs offline.

16. The computer program product of claim 13, wherein fault localization occurs online in real-time.

17. The computer program product of claim 13, further comprising program code to apply transitive reduction to the learned causal graph.

18. The computer program product of claim 13, wherein the program code to leverage the ancestral matrix identifies a plurality of potential sources of the error, and further comprising program code to apply a distance metric to estimate the error source, wherein the distance metric comprises a Hamming distance or cosine similarity.

19. A computer-implemented method comprising:
training an artificial intelligence (AI) model, including:
collecting first error log data corresponding to one or more selectively injected micro-service faults; and
learning a causal graph based on the collected first error log data, the causal graph representing dependency of effected application micro-services; and
dynamically localizing an application fault, including:
collecting second error log data corresponding to detection of the application fault;
leveraging the second error log data and the learned causal graph to identify a source of the application fault.

20. The method of claim 19, wherein training the AI model occurs offline and localizing the application fault occurs in real-time.

21. The method of claim 19, wherein dynamically localizing the application fault further comprises applying a distance based thresholding to estimate the source of one or more possible application faults.

22. The method of claim 19, wherein the training the AI model further comprises controlling fault injection and estimating ancestral edges for the micro-service in receipt of the fault injection.

23. The method of claim 22, wherein training the AI model further comprises applying transitive reduction to the learned causal graph, the transitive reduction combining estimated ancestral edges from two or more controlled fault injections.

24. A computer-implemented system comprising:
a computer processor operatively coupled to memory;
an artificial intelligence (AI) platform in communication with the computer processor and memory, the AI platform comprising:
a staging manager configured to train an AI model, including:
collect first error log data corresponding to one or more selectively injected micro-service faults; and
learn a causal graph based on the collected first error log data, the causal graph representing dependency of effected application micro-services; and
a production manager, operatively coupled to the staging manager, configured to dynamically localize an application fault, including:
collect second error log data corresponding to detection of the application fault; and
leverage the second error log data and the learned causal graph to identify a source of the application fault.

25. The computer system of claim 24, further comprising the production manager configured to apply distance based thresholding to estimate the source of one or more possible application faults.
